(19) United States
(12) Patent Application Publication
(10) Pub. No.: US 2010/0126826 A1
(43) Pub. Date: May 27, 2010

(54) Package diverting mechanism for conveyor systems

(76) Inventors: Robert Dana Lundahl, Frederick, MD (US); Robert Wesley Cuthip, Millersville, MD (US); William Douglas Finch, New Windsor, MD (US)

Correspondence Address: Hung Chang LIN, 8 Schindler Ct., Silver Spring, MD, 20903, US

(21) Appl. No.: 12/313,767

(22) Filed: Nov. 25, 2008

(51) Int. Cl. B65G 47/46

(52) U.S. Cl. 198/370.09

(57) ABSTRACT

This invention presents a unique design for a mechanism to be used in conveyors systems to selectively divert or re-direct packages off of the main conveyor and onto a secondary conveyor. This design utilizes a set of discs mounted eccentrically on an axis underneath and perpendicular to the conveying rollers. The discs are positioned edgewise and spaced between the conveying rollers. The rotation of the discs is triggered by the control system to coincide with the presence of the package selected to divert when it is on the conveying surface. The discs are mounted eccentrically in their common axis so when the array of discs is rotated the eccentricity of their rotation makes the edge of the discs extend above the conveying surface to lift the package and change its direction of motion with the tangential speed and direction of the rotating disc(s). A secondary conveyor is positioned next to the main conveyor to receive the package diverted off of the main conveyor.

### BACKGROUND OF THE INVENTION

1. Field of the Invention

This invention relates to package diverting mechanisms that are commonly used in conveyor based material handling systems and specifically to package diverting mechanisms used by the United States Postal service for the processing of standard mail trays.

The United States Postal Service (USPS) is an example of a large material handling operation that routinely processes 500 million pieces of mail every day throughout the 200+ US Mail processing facilities. In the USPS system, mail is sorted into mail trays for handling and transportation to the next mail facility. These cardboard trays are secured with a sleeve and strapping so that they can be conveniently handled as individual packages.

This invention relates to package diverting mechanisms used in conveyor systems to selectively divert or re-direct packages from the main conveyor lines for subsequent processing. The USPS mail trays are specific package of significant interest. However, it should be obvious to one skilled in the art that this package divert mechanism can be applies to many other package diverting applications above and beyond the USPS material handling requirements.

2. Brief Description of Prior Art

Most material handling systems use some type of conveyor equipment to transport and sorting packages. The sorting function is performed by mechanisms along the conveyor that selectively re-direct packages off of the main conveyor line and onto secondary conveyors or “run outs”.

Several different mechanisms have been used to re-direct packages and these mechanisms can be roughly classified as “diverters” or “transfers” based on how they work and the angle of change in the direction of motion for the package.

Package diverters change the direction of motion for the package by less than 90 degrees. The packages generally do not stop as the packages are “turned” off of the main conveyor. These devices are relatively simple and they work well. However, package diverters take more linear distance to perform the diverting function

Package transfers change the direction of motion for the package by 90 degrees. The packages make an abrupt change in the direction of motion as they are “transferred” off of the main conveyor at a right angle. These devices are more complicated than diverting mechanisms. However, they take minimum space to install and there is an additional benefit of changing the orientation of the package relative to the direction of motion. This feature can be exploited in a variety of ways to create systems that can modify tray orientation for other tray processing requirements.

Existing designs perform the transfer action with a powered pusher, or by raising an array of moving belts lifted up from underneath the conveyor. Both techniques have significant drawbacks.

Tray pushers have to be quite strong to push a package quickly off the conveyor sideways before the next package arrives in the same zone. The speed and motion must be carefully controlled and this will typically require an expensive servo controlled actuator. The force required can be quite high and the physical reach can be long to reach across the conveying surface. This presents significant safety issues when applied to packages of any significant size. The pusher solution is also only good for a single direction and cannot perform in a bidirectional manner without significant complication. The high speed, high force, and reach requirements make the tray pusher a challenging solution for anything but very small package handling applications.

The belt style transfer lifts is another common approach to perform the package transfer function. The typical design suspends a belt drive assembly under the conveyor bed where several individual belt drives are held on a common frame and spaced between the conveyor rollers. To perform a package transfer the entire assembly is raised up between the conveyor rollers to lift and the belts are powered to rotated and drive the package off the side of the conveyor. The belt drive assembly is large and heavy and lifting it into position to transfer a package is stressful for an actuating mechanism. Even with spring and counterweights the mass of the assembly is large and the forces required are significant.

Both the “Pusher” approach and the “belt transfer design” are prone to fatigue due to the linear reciprocating motions of their components. The actuation speeds need to be fast to maintain the overall throughput and this only increases the fatigue failures.

### SUMMARY OF THE INVENTION

This invention discloses a new design for a package transfer device where the transfer mechanism is comprised of eccentrically mounted discs turning on a common shaft mounted underneath the roller conveyor. The rotating shaft is oriented perpendicular to the conveyor rollers and discs are fixed to the rotating shaft with a spacing apart to match the spaces between the conveyor rollers. The discs are attached the rotating shaft eccentrically with the same angle of eccentricity between all discs. The vertical position of the rotating shaft and the geometry of the eccentrically rotating discs results in the circumference of the discs extending above the conveying surface during a portion of their rotation. The cam-type action of the eccentrically rotating discs lifts the packages off of the conveying surface and re-directs them off to an adjacent conveyor.

This design has a simpler construction and is more fatigue resistant than previous diverters. The new design has a simpler construction, fewer moving parts, and performs the package divert function will all rotational movements and no reciprocating components. This is a much more robust approach and inherently fatigue resistant.

This design can also provide a bidirectional capability where packages can be transferred in either direction by simply reversing the rotation of the eccentric disc assembly. The bi-directional capability can be utilized by system designers to provide two sortation points for the one mechanism

An additional objective of this invention is to provide a mechanical design that can transfer heavier packages with a better mechanical advantage in the lifting design.

Another additional objective of this invention is to provide a mechanical design that uses a minimum number of different parts.

A third additional objective of this invention is to provide a transfer mechanism that is easy to maintain with most of the components serviceable from the top.

### BRIEF DESCRIPTION OF DRAWINGS

FIG. (1) Package transfer device—This illustration shows how the basic transfer module can be integrated into a conveyor system.

FIG. (2) Transfer module—This illustration shows a detailed view of the transfer module and identifies key components used in the transfer operation.

FIG. (3) Transfer disc assembly—This illustration shows a detailed view of the transfer disc assembly.

FIG. (4) Simple end view of the transfer with a package—This illustration shows a simplified end view of the transfer device with a package in position.

FIG. (5) Simple end view of the transfer at the initial stage of package transfer—This illustration shows a simplified end view of the transfer device with a package just starting the transfer process.

FIG. (6) Simple end view of transfer during the actual moment of transfer—This illustration shows a simplified end view of the transfer device with a package in the middle of the transfer process to the adjacent run out conveyor.

FIG. (7) Simple end view of the transfer at the completion of the transfer process—This illustration shows a simplified end view of the transfer device after the package transfer has been performed.

### DETAILED DESCRIPTION OF THE INVENTION

The following sections describe only one embodiment of this invention where the application is for the transfer of US Mail Trays. It should also be clear that this invention can be applied to a variety of material handling applications outside of USPS where there is a similar need to convey packages and divert packages with a simple in-line conveyor mechanism.

FIG. (1) shows an overview of the package transfer device (100) and illustrates how it is incorporated in a conveyor system (200). In the general material flow, a package (300) is delivered by the upstream conveyor (400). The package will pass over the transfer device (100), and flows to the downstream conveyor (500). Additional conveyor sections called “run outs” (600) are positioned adjacent to the transfer module and will receive packages that have been diverted off of the main conveyor flow by the function of the diverting mechanism. These run outs are shown at 90 degrees to the main conveyor. However, they could be configured at other angles or even parallel to the main conveyor and could be made from other conveying surfaces including belts, roller balls, gravity conveyor, metal slides, drop holes, etc. Packages that are not selected for transfer will proceed across the transfer and in the direction of normal package flow (700).

FIG. (2) shows a more detailed view of the transfer device itself and highlights several of the key features. In this embodiment “Motorized powered Rollers” (800) are used to convey product across the transfer unit in the normal direction of flow (700). Motorized Powered roller, or MPR as its called in the industry is a common material handling product where motors are integrated inside conveyor rollers and these rollers are mechanically connected to several adjacent idler rollers (900) with a simple urethane belt drive band (1000). The powered roller and the idler rollers are thus mechanically connected and operate as a zone with all rollers starting and stopping together. The conveyor control system uses sensors (1100) to sense the presence of packages in the different zones. The embedded logic of a control system will turn powered rollers on and off to effect the logical movement of materials in the conveyor flow. Other techniques to power the conveyor rollers are equally applicable and anticipated by this invention.

One or more discs (1200) are mounted eccentrically on a common axle underneath the conveying surface. The discs are located between the idler rollers (900) and positioned so that they will extend above the top conveying surface for a portion of their revolution about their common axis.

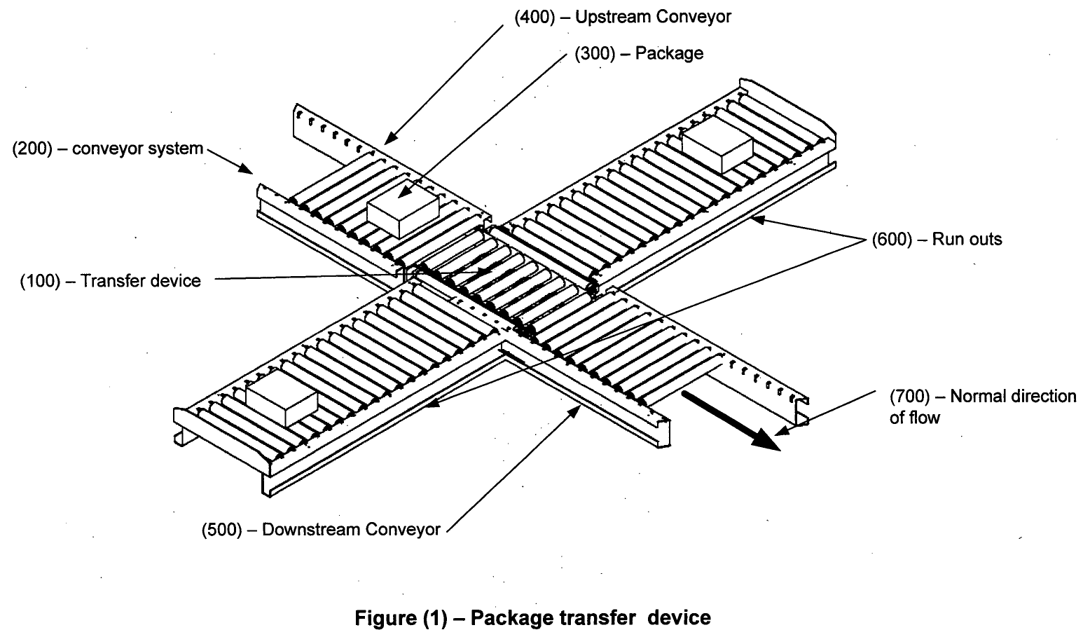

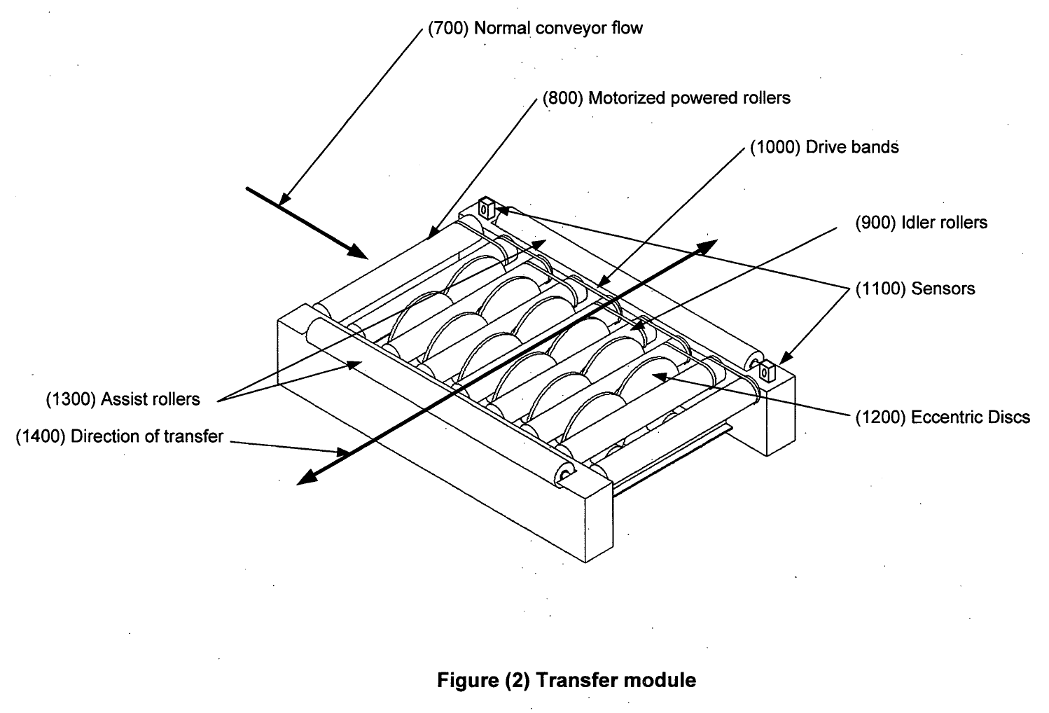

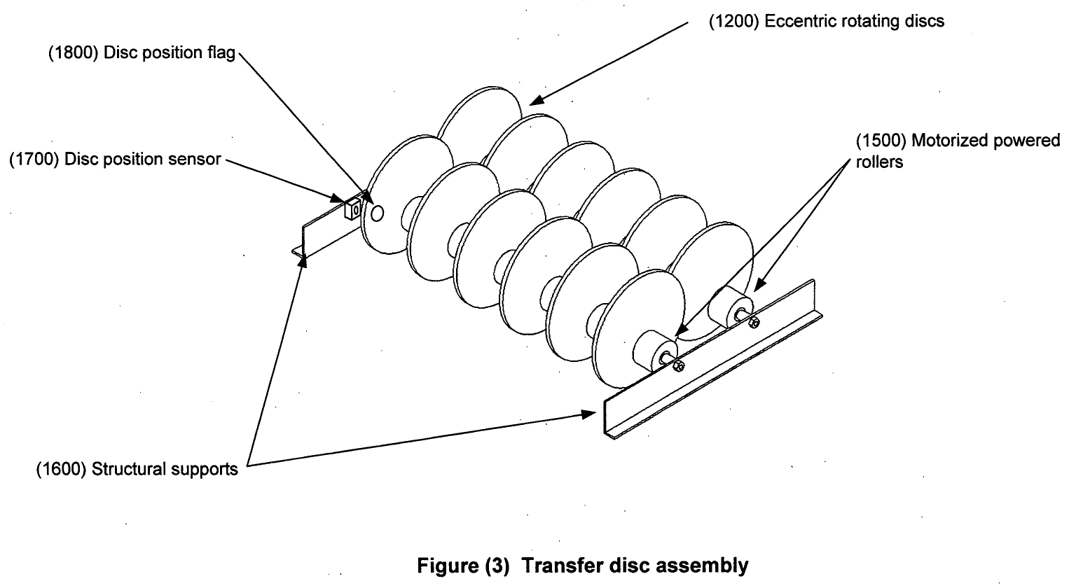

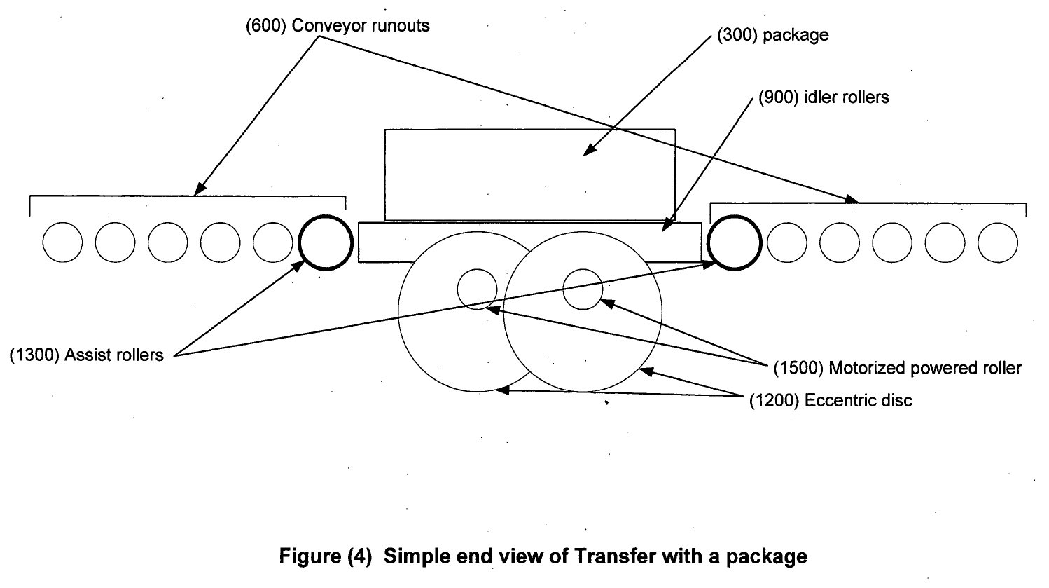

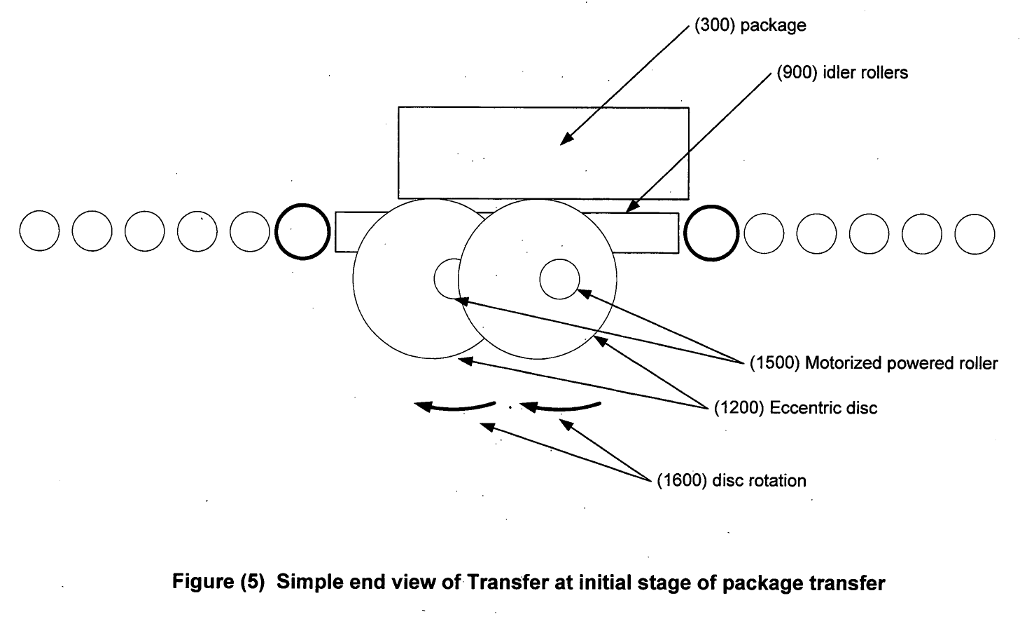

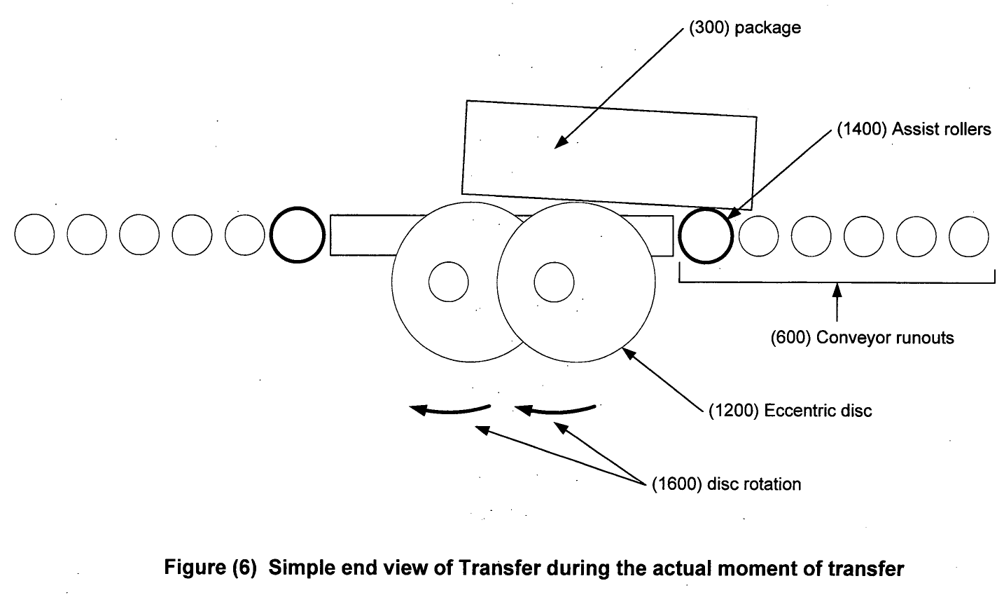

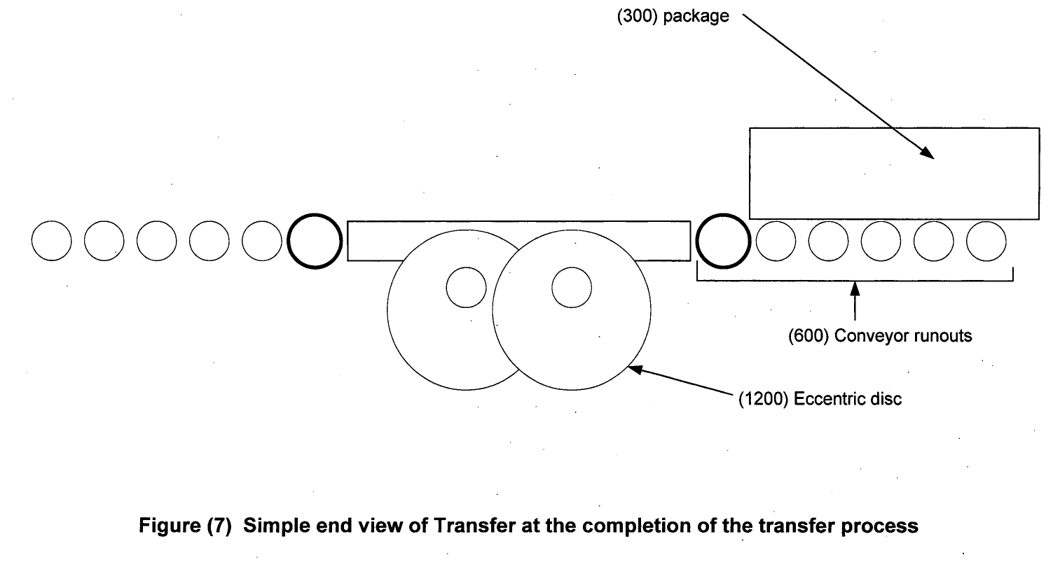

In this embodiment a motorized powered roller (MPR) (Not shown in this figure, see FIG. 3) is also used as the common shaft for the eccentric discs (1200). This provides a convenient approach for mounting and powering the rotation of the eccentric discs (1200) using the standard MPR technology to provide the axle, the rotational power, and the control interface features. It should be obvious to one skilled in the art that there are many other approaches for providing a common axle and rotational movement for the eccentric discs.

The rotation of the eccentrically mounted discs is the unique mechanism that actually performs the package diverting function. As the discs are rotated underneath the conveyor bed they periodically extend above the top of the conveyor rollers lift and propel the package off of the conveying surface. This provides an extremely simple and robust mechanism since the “lifting” and the sideways “trasfer” are performed with the same mechanism and all of the associated motions are rotational.

To enhance the processing speed and reliability, motorized powered rollers are also used as assist rollers (1300) positioned along the side of the conveyor. These rollers are under logical control and are powered so that they also rotate during the transfer operation. The rotation of these rollers is used to assist the package in completing its transition to another conveyor in the direction of transfer (1400). The rotating eccentric discs (1200) move the package to the side of the conveyor where it is engaged by the motorized assist roller (1300) that will mechanically help complete the transfer function.

A bidirectional capability can be realized by commanding the eccentric disc mechanism to turn in either direction and installing the powered assist rollers on either sided of the tray transfer mechanism. With this configuration a control system can signal the mechanism to transfer the package to the right or left directions selectively. The eccentric disc mechanism will rotate in the appropriate direction and the motorized powered assist roller on that side of the conveyor will help complete the transfer onto the adjacent conveyor in the direction of transfer (1400).

FIG. (3) shows the transfer disc assembly itself. In this embodiment the discs (1200) are mounted eccentrically using motorized powered rollers (1500) as an axle whose centerline is offset from the true center of the disc. As a result, the discs will turn eccentrically when the motorized powered roller is rotated. The vertical position of the motorized powered roller and the geometry of the eccentric offset is such that the discs alternately extend above the conveying surface during some part of their rotation. The rollers are mounted on their own structural support (1600) to facilitate the installation and removal for the entire transfer Mechanism.

A disc position sensor (1700) is used to determine the position of the eccentric disc array using a disc position flag (1800) mounted at a know location on the disc array. A conveyor control system coordinates the rotation of the disc array as required for the operation of the transfer device. At the default position the rotation of the eccentric discs (1200) is such that all parts of the disc are below the top conveying surface of the conveyor rollers. In this position any package may be transported down the conveyor and will ride overtop the disc array without interference.

FIG. (4) shows a simplified end view of the transfer device with a package. In this position the transfer is in the “ready to divert” status. The package (300) is on the conveyor idler rollers (900) in position ready to be transferred. The motorized powered rollers (1500) have turned the eccentric discs (1200) into a position where their edges are below the conveying surface. The run outs (600) are depicted on either side of the transfer device. The powered assist rollers (1300) are positioned immediately next to the transfer device to assist the package onto the run out conveyors (600)

FIG. (5) shows the initial stage of the package transfer process. When the transfer is activated by a conveyor control system, the package (300) is stopped. The eccentric discs (1200) mounted to the Motorized powered rollers (1500) begin to rotate (1600) from the low position. When the discs (1200) extend above the conveying surface of the idler rollers (900), they will engage the package (300) and lift it off of the conveying surface. The rotation (1600) of the eccentric discs (1200) provides a cam type mechanical lifting advantage that can lift a heavy package with only a modest rotational torque. As the eccentric discs (1200) continue to rotate (1600), the package (300) begins to move sideways and will continues to move sideways until the top of the rotating eccentric disc(s) (1200) moves below the conveying surface and the weight of the package (300) is transferred back to the conveying surface. This process may be repeated several times as needed. Each rotation of the eccentric disc assembly will similarly lift and transport the package further to the side.

FIG. (6) shows the transfer unit during the actual moment of transfer. Once the package (300) has been lifted and moved far enough to the side by the rotating eccentric discs (1200), it is engaged by the powered assist rollers (1400). The disc rotation (1600) and the rotation of the assist roller (1400) will further propel the moving package (300) onto the new conveyor section run out (600) and thus complete the transfer process.

FIG. (7) shows the transfer unit at the completion of the transfer process. Once the transfer of the package (300) onto the new conveyor run out section (600) is complete, the eccentric discs (1200) are stopped into their initial position where they are below the conveyor surface and the transfer device is ready for a new tray.

What is claimed is:

1. A package transfer device for use with conveying systems comprising:
a frame which provides a supporting structure for conveying surface and diverting mechanism for packages;
multiple rollers supported by the frame to provide the conveying surface with said rollers being powered to rotate,
said diverting mechanism being a transfer mechanism comprised of at least one disc mounted eccentrically on a shaft below the said conveying surface, wherein
said shaft is parallel to the conveying surface and perpendicular to said multiple rollers and,
said discs are mounted eccentrically on said shaft and positioned between said conveyor rollers with a geometry that makes the edge of said discs protrude above said conveying surface for a portion of rotation of said multiple rollers to lift and propel a package off to the side of the conveying surface; and
a control system to control the rotation of said discs where said rotation is selected to divert an incoming package on said conveyer in a direction different from a straightforward direction to a secondary conveyor.

2. The package conveying device as described in claim 1, wherein said control system can be selected to divert said incoming package 90 degrees from said straightforward direction.

3. The package conveying system as described in claim 1, further comprising a disc position sensor to determine the position of the disc, using a disc position flag mounted at a known location on said disc position.
